(19) United States
(12) Patent Application Publication
(10) Pub. No.: US 2001/0045826 A1
(43) Pub. Date: Nov. 29, 2001

(54) Distortion immune magnetic field generator for magnetic tracking systems and method of generating magnetic fields

(76) Inventor: Mark R. Schneider, Williston, VT (US)

Correspondence Address: Lawrence H. Meier, Esq., Downs Rachlin & Martin PLLC, 199 Main Street, P.O. Box 190, Burlington, VT, 05402-0190, US

(21) Appl. No.: 09/809,523

(22) Filed: Mar. 15, 2001

Related U.S. Application Data
(60) Provisional application No. 60/189,726, filed on Mar. 16, 2000.

(51) Int. Cl. G01B 7/14

(52) U.S. Cl. 324/207.17

(57) ABSTRACT

A distortion immune tablet (20) for a position and orientation system (22). The tablet includes a plurality of magnetic field generators (40), a layer of magnetic material (60) and a layer of conductive, non-magnetic material (80). The coils (42) of the generators are oriented relative to the magnetic layer so that the magnetic layer regularly distorts the magnetic fields produced by the generators by creating a positive image of the fields substantially on one side of the magnetic layer. Portions of the magnetic fields passing through the magnetic layer are eliminated by the conductive layer via eddy current effects. The position and orientation system further includes a processor (24) for providing drive signals to the generators and a sensor (26) for sensing the magnetic fields produced by the generators.

This application claims priority on U.S. Provisional Patent Application Serial No. 60/189,726, filed Mar. 16, 2000.

### FIELD OF INVENTION

The present invention relates to a tablet for generating magnetic fields used in connection with systems for determining the position and orientation (P&O) of a remote object relative to a reference coordinate frame. The present invention also relates to a P&O system incorporating such a tablet.

### BACKGROUND OF THE INVENTION

Determining the position and orientation, i.e., location parameters, of objects in free space has many applications. These applications include intrabody tracking, such as catheter tracking, digitizing three-dimensional objects, helmet mounted sighting systems and virtual reality, among others. One method that has been successfully used in these applications relies on the electromagnetic coupling between a source of magnetic fields and the sensing of such fields. Variations include AC and pulsed-DC magnetic field generation, single axis, and multiple axes sensing and generating elements. Examples of AC systems with a plurality of generating and sensing elements are disclosed in U.S. Pat. No. 3,868,565 to Kuipers, U.S. Pat. No. 4,054,881 to Raab, and U.S. Pat. No. 4,737,794 to Jones. Additionally, other position and orientation systems using AC magnetic fields are disclosed in U.S. Pat. No. 6,073,043 to Schneider et al. and pending U.S. patent application Ser. No. 09/370,208 to Schneider, both of which are incorporated herein by reference.

Prior systems are generally hindered by inaccuracies that are caused by the presence of conductive and magnetic materials within the tracking environment. For example, in catheter tracking it is sometimes desirable to place the magnetic field generator of an electromagnetic tracking system on a metal operating room table. This situation also occurs with a 3-dimensional digitizer that is used on a metal desktop. In helmet-mounted sighting systems, where a pilot's line-of-sight is used to target ordinance, a metal headrest is one of the few places that a magnetic field generator can easily be located.

These tracking inaccuracies are caused by eddy current flow in the case of conductive materials and warpage of the fields in the case of magnetic materials. Depending on the composition of the material both effects may be present to various degrees. Eddy currents are due to the time variation of the AC magnetic field, which induces an electric field. This electric field, in turn, causes an electric current (eddy current) to flow in the conducting medium. These eddy currents, in turn, generate their own magnetic field. The eddy currents introduce inaccuracies which prior techniques generally ignore.

Methods have been developed to improve the accuracy of these systems, including characterizing the environment and applying previously stored corrections to the expected fields. The corrections are applied based on the system's present position and orientation. See, for example, the correction techniques described in U.S. Pat. Nos. 4,622,644 to Hansen and 4,945,305 to Blood. Unfortunately, such correction systems never fully address field variations induced by distorters proximate the system.

Other methods include signal generation and processing schemes that allow the induced eddy currents, the source of the inaccuracy, to be eliminated. Such systems utilize pulsed-DC, ramps or multi-frequency excitations. Examples of pulsed-DC systems with a plurality of generating and sensing elements are disclosed in U.S. Pat. No. 4,945,305 to Blood (the “Blood system”) and U.S. Pat. No. 5,453,686 to Anderson (the “Anderson system”). The sensing devices of the Blood system measure fields from DC on up and are thus sensitive to the earth's magnetic field, for which compensation must be provided. The Blood system removes eddy current-induced inaccuracies by applying a DC excitation signal to a field generator and then curve fitting the decay to extrapolate the final sensed value. The Anderson system eliminates the use of DC sensitive field sensing elements and consequently reduces the complexity of the hardware. Anderson's signal processing scheme removes eddy current induced inaccuracies by applying a DC excitation signal to a field generator and integrating the sensed waveform from an AC sensor. This method integrates out the eddy current inaccuracies. In general, the use of pulsed-DC systems reduces the effects of eddy currents, thereby improving accuracy in the presence of conductive materials within the tracking system environment. An important disadvantage of pulsed-DC systems is that they operate only in a time division multiplexed mode, which limits the options for generation and sensing of the magnetic fields. Another drawback with some pulsed-DC systems is the need for bulky and more complex active sensing devices, as compared to sensors used in AC systems.

An example of a ramped system with a plurality of generating and sensing elements is disclosed in co-pending U.S. patent application Ser. No. 09/370,208 to Schneider. This system, like the Anderson system, utilizes AC sensing elements. A time division multiplexed ramped current waveform is applied to the field generators sequentially. The sensed magnetic field data is fit to a low pass filter eddy current model. This allows the eddy current distortions to be subtracted out.

One example of a multi-frequency approach for improving accuracy in the presence of conductive materials is disclosed in U.S. Pat. No. 4,829,250 to Rotier. This AC method with a plurality of generating and sensing elements utilizes multi-frequency excitation of the field generator. Eddy current inaccuracies are a function of frequency. The Rotier method involves extrapolating to DC a curve fit from a higher frequency to a lower frequency to determine the yaw and pitch angles about a line-of-sight axis, which does not include position. In another multi-frequency approach described in U.S. patent application Ser. No. 09/370,208 to Schneider, frequency division multiplexed triangular excitations are applied to the field generators. These produce harmonics at the sensing device. This frequency rich data is fit to a low pass filter frequency model of eddy currents. This again allows the eddy current distortions to be subtracted out.

Another AC method is disclosed U.S. Pat. No. 5,640,170 to Anderson. A spiral conductor pattern is overlaid on a thin insulating sheet, which is then overlaid on a conductive, non-ferromagnetic sheet. This field generating assembly generates a dipole like field. Variations are also disclosed which utilize the assembly to form multi-axis field generators. The Anderson system apparently requires the generation of dipole fields because the position and orientation algorithm used with the assembly is based on a dipole model. Inaccuracies due to a non-ideal dipole field are compensated by correction methods mentioned above. As noted above, such correction methods are less than ideal, as they never completely compensate for variations in the fields caused by distorters.

Anderson's field generating assembly eliminates any distortions due to distorters that are behind the assembly. This is especially useful in restricted tracking volumes such as those encountered in medical applications, including catheter and endoscope tracking, orthopedic measurements and locating biopsy sites. Three-dimensional digitizing, including the localization of two-dimensional ultrasound and laser scanners to produce three-dimensional data, would also be served by such a system.

### SUMMARY OF THE INVENTION

One aspect of the present invention is a magnetic field generator tablet. The tablet comprises a first layer of material that is magnetically conductive, which layer has a first major surface and a second major surface opposite the first major surface. The tablet also includes a plurality of magnetic field generators located proximate the first layer of material. Each of the generators has a coil or coil equivalent capable of generating a magnetic field, which coil or coil equivalent has a major plane extending substantially parallel to the first major surface. The first layer of material has a thickness and a relative permeability μᵣ selected so that the first layer of material substantially prevents the magnetic fields from extending through the first layer of material and past its second major surface.

Another aspect of the present invention is a magnetic field generator tablet that is similar to the tablet described above, except that it includes a layer of non-magnetic electrically conductive material in place of the layer of magnetic material. Also, the major plane of the coil of the generators extends substantially normal to a surface of the layer of conductive material.

Yet another aspect of the present invention is a magnetic field generator tablet including both a layer of magnetic material and a layer of non-magnetic electrically conductive material. When the layer of magnetic material is positioned closer to the generators than the layer of conductive material, the generators are oriented so that the major plane of their coils extends substantially parallel to the first major surface of the layer of magnetic material. Conversely, when the layer of conductive material is positioned closer to the generators, the major plane is positioned substantially normal to the first major surface. Still another aspect of the present invention is a position and orientation system incorporating tablets of the type described above and further including a sensor and a processor. The sensor senses the magnetic fields and provides an output signal having information representative of the magnetic fields. The processor is connected to the tablet and the sensor and provides drive signals to the plurality of magnetic field generators and determines the position and orientation of said sensor in space based on the information in the output signal of the sensor.

Yet another aspect of the present invention is a method of distorting magnetic fields. One step in the method is providing a layer of magnetic material having a first thickness, a first relative permeability μᵣ, a first major surface and a second major surface opposite the second major surface. Another step involves providing a layer of non-magnetic, electrically conductive material having a first thickness, a first resistivity ρ, a first major surface and a second major surface opposite the first major surface. Next, the layers of magnetic material and electrically conductive material are positioned proximate at least one magnetic field generator capable of generating a magnetic field. Next, at least one magnetic field is generated with the at least one magnetic field generator. The method further involves selecting the first thickness and the first relative permeability μᵣ of the layer of magnetic material and selecting the first thickness and first resistivity ρ of the layer of conductive material so that in combination the layer of magnetic material and the layer of electrically conductive material substantially prevent the at least one magnetic field from extending through both the layer of magnetic material and the layer of electrically conductive material.

### BRIEF DESCRIPTION OF THE DRAWINGS

The invention will now be described in more detail, by way of example, with reference to the accompanying drawings, in which:

FIG. 1 is a schematic perspective view of one embodiment of the tablet of the present invention, together with a block diagram depiction of the processor and sensor of the system with which the tablet is used;

FIG. 2 illustrates the position of a “Z” sensor of the present invention in an X-Y-Z coordinate system;

FIG. 3 is an idealized depiction of a magnetic dipole field having its central plane extending vertically;

FIG. 4 is an idealized depiction of the field of FIG. 3, which has been distorted by the tablet of FIG. 1;

FIG. 5 is similar to FIG. 1, except that a second embodiment of the tablet is illustrated;

FIG. 6 illustrates the position of a “Y” sensor of the present invention in an X-Y-Z coordinate system;

FIG. 7 is similar to FIG. 3, except that the central plane extends horizontally;

FIG. 8 is an idealized depiction of the field of FIG. 7, which has been distorted by the tablet of FIG. 5; and

FIG. 9 is a schematic depiction of the P&O system of the present invention.

### DETAILED DESCRIPTION OF THE INVENTION

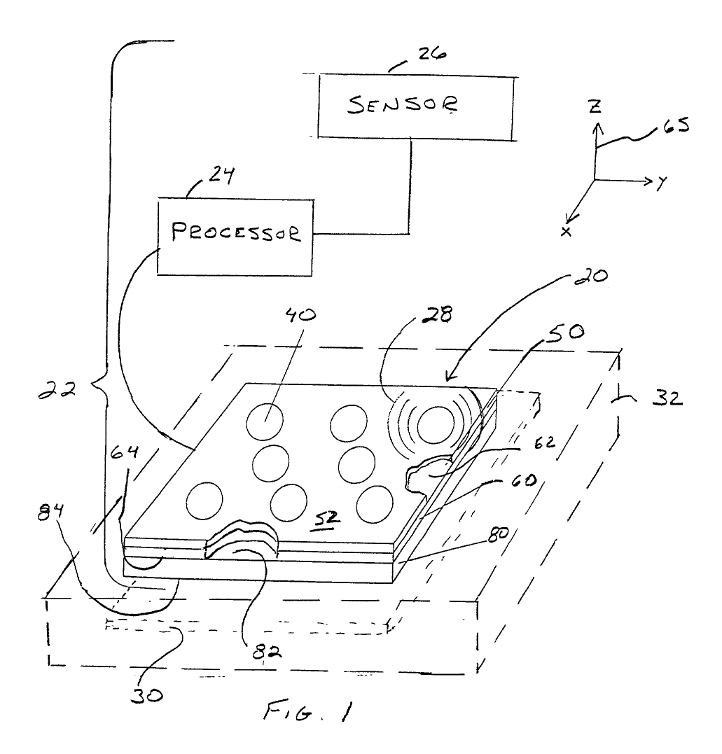

The present invention is a distortion immune magnetic field generator tablet 20 for use in a P&O magnetic tracking system 22 that additionally includes a processor 24 and a sensor 26, as shown in FIG. 1. As described below, tablet 20 generates regularly distorted magnetic fields 28 that are substantially immune to magnetic fields distorters 30 positioned in region 32 located below the tablet. Distorters 30 may include, for example, the steel frame of an examination table, magnetic fields created by electrical conductors carrying alternating current, and concrete floors, walls, ceilings or other structures containing rebar.

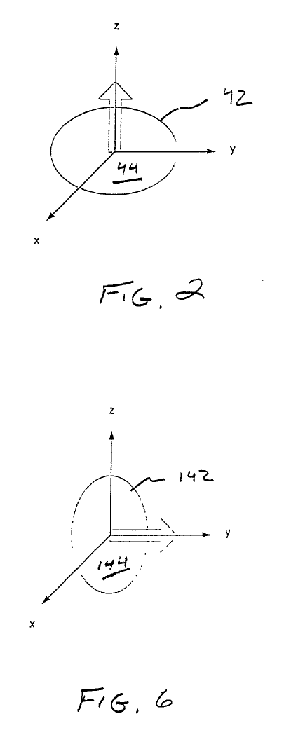

Referring now to FIGS. 1 and 2, tablet 20 includes a plurality of magnetic field generators 40. Each generator 40 has a coil or coil equivalent 42 (described below) having a major plane 44 extending substantially normal to the central axis of the coil and intersecting the coil. The term “coil 42” is frequently used generically herein to cover both coils of wire and coil equivalents. The present invention encompasses as generators 40 any known device capable of generating magnetic fields. In this regard, generators 40 include orthogonal sets of coils, planar coils, overlapped and stacked coils, tetrahedral coils, and rotating or vibrating magnets. When generator 40 is implemented as a rotating or vibrating magnet, no actual coil is, of course, present. However, such magnets can be represented by a coil of wire having an appropriate size, position, number of turns, magnetic moment, and the like, which imaginary coil is described herein as a “coil equivalent”. In any event, when magnets are used as generators 40, devices for causing the magnets to move, e.g., rotate or vibrate, in known or controlled fashion are connected, directly or indirectly, to the magnets. Examples of suitable devices for moving the magnets includes piezo-electric devices, servo drives and micro motors.

The number of generators 40 used will vary depending upon the number of degrees of freedom of system 22 and whether more information is desired than is minimally required. However, at least five generators 40 are typically used for a system 22 having five degrees of freedom (i.e., X, Y, Z, azimuth and elevation), and at least six generators 40 are used when six degrees of freedom is desired (i.e., X, Y, Z, azimuth, elevation and roll). Eight generators 40 are provided in the embodiment illustrated in FIG. 1 to obtain additional information, thereby potentially improving position and orientation determination by system 22 due to the availability of eight equations with five unknowns.

Tablet 20 typically includes an insulator layer 50 positioned below generators 40. Insulator layer 50 may be made from a dielectric material such as mylar (e.g., 0.005″-0.010″ thick), fiberglass or other printed circuit board material (e.g., 0.0625″ or more thick), an actual printed circuit board with no traces on the bottom surface, a multi-wire board, and an air gap formed by displacing generators 40 from magnetic layer 60, as discussed below. In one embodiment, generators 40 and insulator layer 50 are combined in the form of a printed circuit board with no coil traces on the bottom side or with the traces covered, e.g., by solder mask material. When insulator layer 50 is an air gap, generators 40 may be positioned on bobbins or other structure that position the generators above tablet 20 by about 0.125″ or more. When each generator 40 includes its own insulation, or is otherwise electrically insulated from other generators, layer 60 may be omitted or may be made from materials other than dielectrics.

Referring now to FIGS. 1-3, tablet 20 also includes a layer of magnetic material 60 positioned beneath insulator layer 50, if provided. Magnetic layer 60 has a first major surface 62 and a second major surface 64 opposite surface 62. Surfaces 62 and 64 extend substantially parallel to the X-Y plane defined by the X and Y coordinates of the X-Y-Z coordinate system 65 in which tablet 20 is used. Magnetic layer 60 is preferably sized to cover the entire distorter 30 adjacent to which it will be used, or at least that portion of the distorter capable of intermittently distorting field 28. Magnetic layer 60 also preferably extends beyond generators 40 an amount equal to at least one to ten times the diameter of coil 42, as measured from the center of the coil. Magnetic layer 60 may be made from a continuous sheet of material, with or without perforations, from a mesh or screen, from strands of material, alone or embedded in other material, or may have another physical configuration.

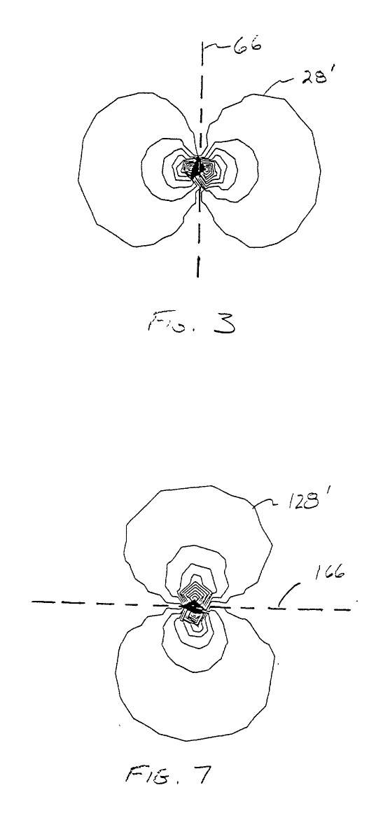

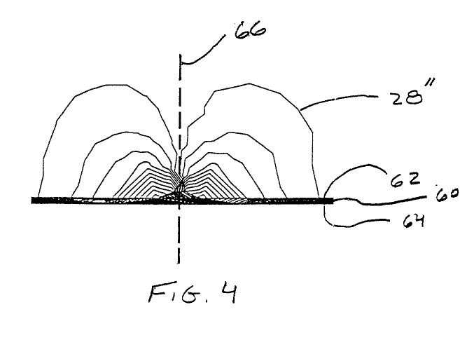

In the embodiment of the present invention illustrated in FIG. 1, generators 40 are oriented relative to surface 62, so major planes 44 of coils 42 extend substantially parallel to first major surface 62 of magnetic layer 60. In other words, planes 44 extend parallel to the X-Y plane of coordinate system 65, with coils 42 thereby being described as “Z” coils. When generators 40 create a magnetic dipole field 28′ having a central plane 66 bisecting the field, as illustrated in FIG. 3, the previously described placement of coils 42 results in plane 66 being positioned to extend substantially normal to first major surface 62 of magnetic layer 60, as illustrated in FIG. 4. When generators 40 create other magnetic field configurations, other physical relationships between the field and the first major surface 62 may exist. In one embodiment of the present invention, generators 40 are planar coils laid on surface 52 of insulator layer 50, with the later being a printed circuit board. This allows for a thin package design and excellent manufacturing tolerances and repeatability.

Perfect magnetic conducting planes influence the configuration of a magnetic field 28 formed at the surface of the plane by a generator 40 oriented so that the major plane 44 of its coil 42 extends parallel to the magnetic conducting plane. This influence results in the theoretical doubling of the electromagnetic field on the side of the perfect magnetic conducting plane where generator 40 is positioned and the reduction to theoretically zero the field on the opposite side of the plane. This positive image formation is illustrated in FIG. 4, where for purposes of illustration magnetic material layer 50 shown in FIG. 4 is presumed to be a perfect magnetic plane. FIG. 3 shows an undistorted magnetic dipole field 28′ and FIG. 4 shows a distorted field 28″ positioned so its central plane 66 extends substantially normal to first major surface 62 of magnetic layer 60. As illustrated, field 28″ is distorted by layer 60 so that no portion of the field extends past second major surface 64. Similar distortion will exist relative to other fields formed from generators 40 having coils 42 of geometries other than circular, such as ellipses or triangles, or, more generally polygons, where their coils 42 are positioned so as to extend parallel to first major surface 62. Similar distortion will exist relative to other fields 28 formed from current elements or current sheets with return paths beneath magnetic layer 60 that have their current flow positioned substantially parallel to first major surface 62. Conversely, a magnetic dipole field 28′ positioned so that plane 66 extends parallel to first major surface 62 forms a negative image. As perfect magnetic planes do not exist, in practice layer 50 is less than perfectly magnetically conducting, as described in more detail below.

Magnetic layer 60 is made from a material selected to form a positive or doubled image of field 28 such that almost none of the field escapes through the magnetic layer and past its second major surface 64. This is not the case with purely conductive material of the type used in known magnetic tracking tablets, such as the one described in U.S. Pat. No. 5,640,170 to Anderson, e.g., aluminum or copper. These materials generate large eddy current components, and, unless quite thick, allow fields to penetrate through them, where they are further distorted by other conductive or magnetic materials below. These effects directly affect the field structure above the field generators.

Suitable magnetic materials for magnetic layer 60 have a large relative permeability (μᵣ), preferably ranging from 50 to over 2,000,000 Henrys/meter. These materials include common cold rolled steels, mu-metals and ferrites. A thinner layer of highly permeable material can be substituted for thicker material with lower permeability. With this trade off in mind, layer 60 will generally have a thickness ranging from 0.005″ to 3″. Material availability, cost, weight, acceptable overall thickness of tablet 20 and other factors will influence material selection and thickness. In one implementation of tablet 20, a suitable magnetic material for magnetic layer 60 is mu-metal, e.g., Mil-N-14411C, composition 1, composed of 80% Iron-Nickel alloy, with an initial relative permeability μᵣ of 30000, 0.015″ thick, available from Mu-Shield of New Hampshire.

Tablet 20 further includes a non-magnetic, electrically conductive layer 80 having a first major surface 82 and a second major surface 84 opposite the first major surface. Conductive layer 80 is positioned beneath layer 60 so that its surface 82 confronts surface 64. Conductive layer 80 is preferably sized to be substantially coextensive with magnetic layer 60, although other relative sizing may be accommodated. Conductive layer 80 may be made from materials such as aluminum and copper alloys having a low resistivity ρ, generally ranging from 1.5 to 20×10⁻⁸ ohm-meters, or superconducting materials. The thickness of conductive layer 80 generally ranges from 0.010″ to 3″, with thickness typically being selected as a function of resistivity ρ. The resistivity ρ and thickness of conductive layer 80 are also selected as a function of the spacing between generators 40 and distorters 30, cost, weight, acceptable overall thickness of tablet 20, magnetic flux density of portions of field 28 extending through magnetic layer 60 and past second major surface 64 and other factors. Conductive layer 80 may be made from a continuous sheet of material, with or without perforations, from a mesh or screen, from strands of material, alone or embedded in other material, or may have another physical configuration.

In one implementation of tablet 20, where the tablet is intended to be placed immediately over a distorter 30, such as a steel framed operating room table, conductive layer 80 is preferably about 0.25″ thick when comprised of Aluminum 6061. When tablet 20 is elevated above the distorter 30, thinner conductive material can be used. For example, when tablet 20 is positioned so that generators 40 are about 1.5″ above the distorter, conductive layer 80 may be 0.125″ thick Aluminum 6061. The latter material may be obtained from McMaster-Carr Supply Company, New Brunswick, N.J.

If desired, a spacer layer (not shown in FIG. 1) may be positioned between generators 40 and layers 60 and 80 to reduce the intensity of distortion of field 28 above first major surface 62 by increasing the spacing of the field from distorter 30. Spacer layers having a thickness in the range of 1-2″ and made from a non-magnetic and high resistivity material such as PVC, fiberglass, air or other dielectrics have been determined to function effectively. When the spacer layer is an air layer, legs, blocks, studs or other structure is provided within tablet 20 so as to space apart layers 60 and 80 or space generators 40 from such layers, thereby creating the air layer. Alternatively, the spacer layer may comprise such structure positioned beneath tablet 20 so as to space the bottom portion of the tablet from the distorter 30. The spacer layer minimizes the distortion effects of magnetic layer 60 on field 28, thereby simplifying signal processing. However, distortion due to edge effects becomes more prominent. Edge effects may arise due to fields 28 wrapping around the edges of tablet 20 and interacting with the magnetic and conductive materials below. Edge effects need to be evaluated when designing tablet 20 for a particular application. To combat this problem, magnetic layer 60 and conductive layer 80 may be sized to extend beyond the tracking volume. Placing a large gap, as noted previously, between the metal immune field generator and the table also alleviates the problem.

In the embodiment of the present invention illustrated in FIG. 1, major plane 44 of coil 42 extends substantially parallel to first major surface 62 of magnetic layer 60, as described above. The term “substantially,” as used in this context, includes a divergence from a perfectly parallel relationship that will vary as a function of the thickness and relative permeability (μᵣ) of magnetic layer 60, the thickness and low resistivity ρ of conductive layer 80, the strength and configuration of field 28, tracking tolerances and other factors. As major plane 44 is inclined more and more relative to first major surface 62, the doubling effect of field 28 above magnetic layer 60 and the cancellation effect of the field below the magnetic layer decreases. Those skilled in the art can readily determine by empirical testing when major plane 44 is no longer “substantially” parallel to first major surface 62. This determination is achieved by incrementally inclining major plane 44 away from a perfectly parallel relationship with first major surface 62 and then monitoring the impact, for each increment, of field 28 on position and orientation information provided by system 22. Eventually, a point will be reached with such incremental changes in inclination where the deviation of major plane 44 away from a perfectly parallel relationship with first major surface 62 causes sufficient modification of field 28 away from the theoretically perfect doubling of field 28 above magnetic layer 60 and the theoretically perfect cancellation of the field below the magnetic layer is unacceptable. This occurs when the position and orientation information developed by the system 22 with which the tablet 20 is used is so far from the corresponding actual position and orientation as to be unusable for the intended application. This point defines when major plane 44 is no longer “substantially” parallel to first major surface 62.

Referring to FIGS. 1-4, in operation generators 40 of tablet 20 generate fields 28 upon receipt of drive signals from processor 24, as described in more detail below in connection with the description of the entire system 20. These drive signals are generated so as to create unique attributes for each field, e.g., frequency, phase, time. These unique attributes permit each field 28 to be distinguished from other fields in connection with the tracking operation. Fields 28 are distorted by magnetic layer 60, as noted above, so as to create a positive image of the field above first major surface 62 and to minimize the portion of the field extending through the magnetic layer and past its second major surface 64. An important aspect of the present invention is that the distortion of fields 28 caused by magnetic layer 60 has a consistent and known configuration irrespective of the presence of distorter 30.

Because magnetic layer 60 is not a perfect magnetic conductor some portion of field 28 typically extends past second major surface 64. Conductive layer 80 is provided to account for such leakage. Conductive layer 80 effectively eliminates such field leakage through eddy current effects.

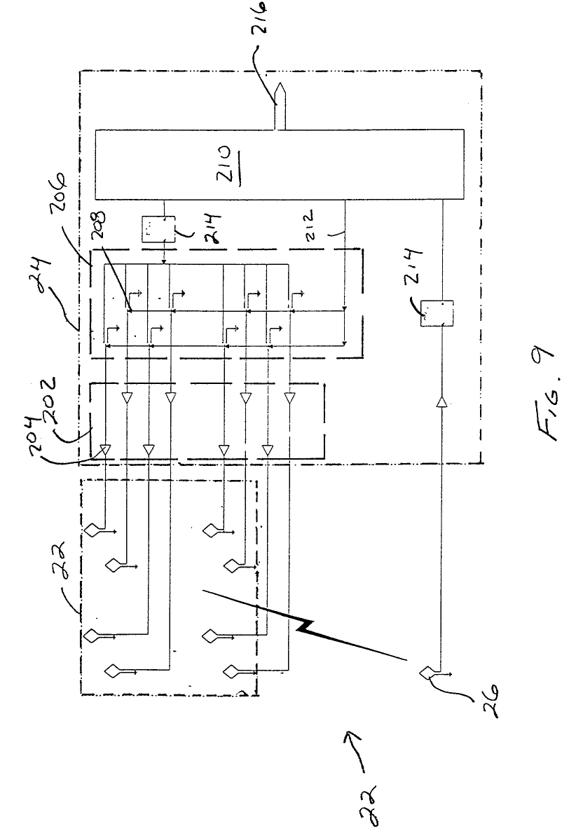

Referring now to FIGS. 5-8, the present invention also encompasses a “Y” coil version of tablet 20, as described in more detail below. Tablet 120 is quite similar to tablet 20, with corresponding structure and fields being identified with the same reference numbers as those used to describe tablet 20, except that a “100's” series prefix has been used. For instance, conductive layer 180 in tablet 120 corresponds to conductive layer 80 in tablet 20. To avoid duplicate description, attention is directed to the preceding discussion of tablet 20 for an understanding of the elements of tablet 120, with the exception of the differences described below.

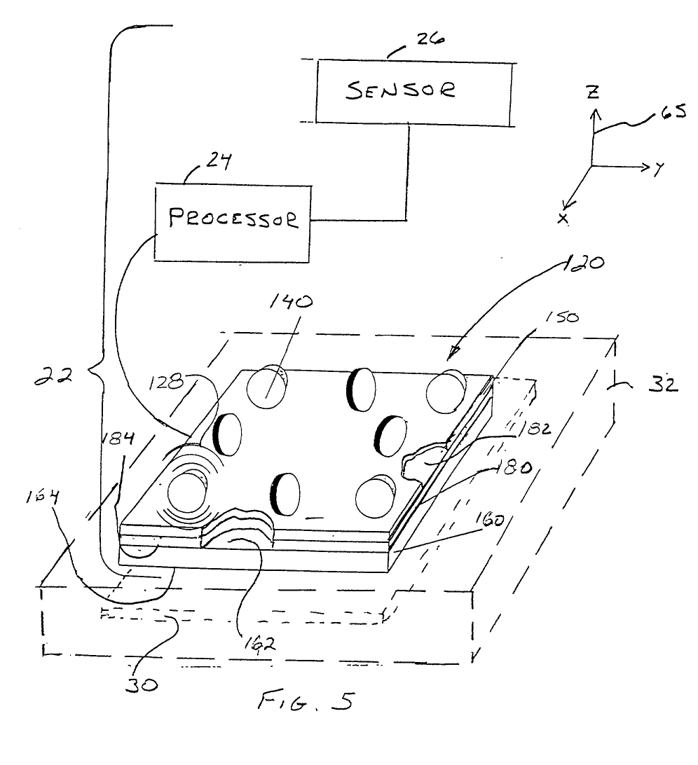

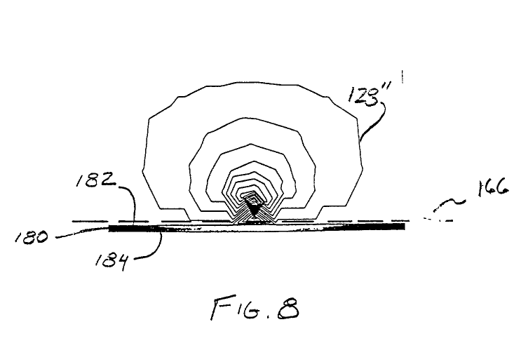

With reference to FIGS. 5-8, while generally similar to tablet 20, tablet 120 differs in two important respects. First, generators 140 are positioned so that the major planes 144 of their coils 142 (or coil equivalents, which the term coil 142 “encompasses”) extend normal to first major surface 162 of magnetic layer 160. Thus, major planes 144 also extend normal to first major surface 182 of conductive layer 180 and to the plane defined by the X-Y coordinates of X-Y-Z coordinate system 65, as illustrated in FIG. 6. Thus, coils 142 may be described as “Y” coils for the purpose of the present invention. However, it is to be appreciated that the term “Y coil” is being used in a broader sense than is conventional and is shown in FIG. 6. As used herein, “Y coil” is any coil 142 having its major plane 144 normal to first major surface 182, regardless of rotational orientation of the coil relative to the Z axis of the X-Y-Z coordinate system 65. Thus, rather than lying exclusively in the X-Z plane as illustrated in FIG. 6, Y coil 142 may lie in the Y-Z plane or any plane in between, the only requirement being that the its major plane 144 extend normal to the X-Y plane, i.e., the plane of first major surface 182. As a consequence of this orientation, if generator 140 is designed to generate a magnetic dipole field 128′ then its central plane 166 will extend parallel to first major surface 162 of magnetic layer 160, as shown in FIG. 7. As described in more detail below, magnetic layer 160 and conductive layer 180 distort field 128′ so as to create field 128″.

Tablet 120 also differs from tablet 20 in that the relative position of magnetic layer 160 and conductive layer 180 is reversed, i.e., second major surface 184 confronts first major surface 162. In this regard, generators 140 positioned on insulating layer 150 are positioned closer to conductive layer 180 than magnetic layer 160.

In operation, conductive layer 180 generates a positive image of fields 128 such that almost no portion of the fields extends through the conductive layer and past second major surface 184. Those portions of fields 128 that do extend past second major surface 184 are essentially distorted or warped back by magnetic layer 160 to above first major layer 162.

While tablets 20, 120 have been described as including both magnetic layers 60, 160 and electrically conductive layers 80, 180, the present invention is not so limited. Depending upon the intended application for tablet 20, 120, the thickness and relative permeability μᵣ of magnetic layers 60, 160, the thickness and resistivity ρ of conductive layers 80, 180, the spacing of tablet 20, 120 from the distorter 30, the orientation of major planes 44, 144 relative to X-Y-Z coordinate system 65, and other factors, it may be possible eliminate either the magnetically conductive layers or the electrically conductive layers.

Turning now to FIGS. 1, 4 and 9, the present invention also comprises a magnetic tracking system 22 incorporating tablet 20 or 120, as referenced above. In connection with the following description of system 22, for simplification of description only the elements of tablet 20 will be discussed. However, it is to be appreciated that tablet 120 may be readily substituted for tablet 20 and so the description applies equally to the elements of tablet 120.

Processor 24 includes a driver 202 having a plurality of current drivers 204, one for each generator 40. Current drivers 204 provide time, frequency, or phase-division multiplexed waveforms to generators 40 (only time-division multiplexing being shown), with one current driver preferably being provided for each generator. The signals provided by current driver 204 are multiplexed so that fields 28 provided by each of the generators 40 are distinguishable from one another, whether by time, frequency or phase. The multiplexing is accomplished by multiplexer 206, which is illustrated as a set of switches 208. Processor 24 includes a CPU 210 that causes switches 208 to actuate in sequences via signals delivered from the CPU over bussed output lines 212. A digital-to-analog converter (DAC) 214 is driven by CPU 210 to generate the analog signal that is supplied as input to current drivers 204 in response to multiplexer 206. Processor 24 also includes an interface 216 connected to CPU 210 for permitting system 22 to communicate with other devices.

Sensor 26 is preferably a passive loop antenna that responds to the rate of change of magnetic field dB/dt. The output of sensor 26 is provided to differential preamp 218. The output of the latter is supplied to analog-to-digital converter (ADC) 220, which converts the amplifier output to a discrete time digital representation for processing by CPU 210.

For a more detailed description of a suitable processor 24 and sensor 26, and the operation of same, attention is direction to pending U.S. patent application Ser. No. 09/370,208 to Schneider entitled Position and Orientation Measuring With Magnetic Fields, the contents of which are incorporated herein by reference. This application is referred to herein as the '208 application. It is to be appreciated, however, that table may be used with virtually any magnetic tracking position and orientation system.

In operating system 22, distorted fields 28 (i.e., distorted by tablet 20) from generators 40 are measured on a three-dimensional grid above the field generator. This data is then processed to produce position and orientation information relative to sensor 26. In the technique of the '208 application, this data is processed to produce a three-dimensional curve fit. The curve fit replaces the numerous mathematical descriptions (models) of different field generators used by other practitioners of the art. Since the curve fit is not based on a model, but purely on actual measured data, warped, atypical fields, such as those produced by tablet 20 can be accommodated. The curve fit accounts for the fact that there is no such thing as a perfect electrically or magnetically conductive layer (unless exotic technologies are used, e.g. superconducting materials) and that layers constructed of typical materials exhibit both types of behavior. Atypical fields also arise from cross coupling in the electronic circuitry and other imperfections.

One method for evaluating various configurations of tablet 20 is to mock up a particular design using one generator 40 and then noting the disturbances of field 28 that occur when a magnetic or conductive item is introduced below. Another method is simulation, using products such as the one identified by the mark Quickfield™ which is sold by Tera Analysis Ltd. located in Knasterhovvej 21, DK-5700 Svendborg, Denmark.

Tablet 20 may be used with tracking systems other than the one disclosed in the '208 application. For example, tablet 20 can also be applied to the tracking methods, systems and algorithms such as those disclosed in U.S. Pat. Nos. 5,307,072 to Jones, 4,945,305 to Blood, and 5,558,091 to Acker, and also in International Application WO96/05768 to Ben-Haim. Algorithms based on gradient measurements and tensor field measurements can be accommodated. Other known techniques for tacking sensor position and orientation benefit similarly from the use of tablet 20.

As used herein, common the terms “above” and “beneath” are not intended to limit the absolute orientation of tablet 20. Thus, tablet 20 may be used in any orientation in space.

Tablet 20 enjoys a very important advantage over known tablets used in position and orientation systems. By distorting fields 28 in a consistent manner so as to have a known configuration, system 22 becomes immune to the adverse effects of distorters 30 positioned beneath tablet 20. When processor 24 operates as described in U.S. patent application Ser. No. 09/370,208, as a consequence of the immunity tablet 20 provides it becomes unnecessary to perform correction of position and orientation information developed by system 22 such as is done with prior art systems. Such correction is inherently difficult to accurately and consistently generate for a wide range of distorters 30 adjacent to which a position and orientation system may be used But more generally, regardless of the type of position and orientation system with which tablet 20 is used, immunity from distorters positioned beneath the tablet is provided.

While system 22 has been described such that generators 40 are positioned adjacent tablet 20, it is to be appreciated that the present invention encompasses positioning sensor 24 adjacent tablet 20. In this reversal of elements, generators 40 would be positioned where sensor 24 would normally be positioned.

While the present invention has been described in connection with various embodiments, it will be understood that it is not so limited. On the contrary, it is intended to cover all alternatives, modifications and equivalents as may be included within the spirit and scope of the invention as defined in the appended claims.

What is claimed is:

1. A magnetic field generator tablet, comprising:
a) a first layer of material that is magnetically conductive, said first layer of material having a first major surface and a second major surface opposite said first major surface;
b) a plurality of magnetic field generators located proximate said first layer of material, each of said generators having a coil or coil equivalent capable of generating a magnetic field, said coil or coil equivalent having a major plane extending substantially parallel to said first major surface; and
c) wherein said first layer of material has a thickness and a relative permeability μᵣ selected so that said first layer of material substantially prevents said magnetic fields from extending through said first layer of material and past said second major surface.

2. A tablet according to claim 1, wherein said first layer of material has a thickness ranging from 0.005″ to 3″ and a relative permeability μᵣ ranging from 50 to 2,000,000 Henrys/meter.

3. A tablet according to claim 1, wherein said magnetic field is a dipole having a central plane extending substantially normal to said first major surface.

4. A tablet according to claim 1, further including a bottom surface and a spacer layer for increasing the distance between said plurality of magnetic field generators and a distorter proximate said bottom surface.

5. A tablet according to claim 1, wherein said plurality of magnetic field generators includes coils.

6. A tablet according to claim 1, wherein said plurality of magnetic field generators includes magnets.

7. A magnetic field generator tablet, comprising:
a) a first layer of material that is magnetically conductive, said first layer having a first major surface and a second major surface opposite said first major surface;
b) a second layer of material that is electrically conductive and non-magnetic, said second layer positioned proximate said second major surface of said first layer;
c) a plurality of magnetic field generators located proximate said first layer of material, each of said generators having a coil or coil equivalent capable of generating a magnetic field, said coil or coil equivalent having a major plane extending substantially parallel to said first major surface; and
d) wherein said first layer of material has a thickness and a relative permeability μᵣ selected so that said first layer of material substantially prevents said magnetic fields from extending through said first layer and past said second major surface.

8. A tablet according to claim 7, wherein said first layer of material has a thickness ranging from 0.005″ to 3″ and a relative permeability μᵣ ranging from 50 to 2,000,000 Henrys/meter.

9. A tablet according to claim 7, wherein said magnetic field is a dipole having a central plane extending substantially normal to said first major surface of said first layer of material.

10. A tablet according to claim 7, wherein said second layer of material has a thickness ranging from 0.010″ to 3″ and a resistivity ρ ranging from 1.5 to 20×10⁻⁸ ohm-meters.

11. A tablet according to claim 7, wherein said second layer of material has a thickness and resistivity ρ selected so that said second layer of material substantially eliminates via eddy currents any portions of said magnetic fields that extend through said first layer of material past said second major surface thereof.

12. A tablet according to claim 7, wherein said plurality of magnetic field generators includes coils.

13. A tablet according to claim 7, wherein said plurality of magnetic field generators includes magnets.

14. A magnetic field generator tablet, comprising:
a) a first layer of material that is magnetically conductive, said first layer having a first major surface and a second major surface opposite said first major surface;
b) a second layer of material that is electrically conductive and non-magnetic, said second layer positioned proximate said first layer;
c) a plurality of magnetic field generators, each of said generators capable of generating a magnetic field; and
d) wherein said first layer of material has a thickness ranging from 0.005″ to 3″ and a relative permeability μᵣ ranging from 50 to 2,000,000 Henrys/meter.

15. A tablet according to claim 14, wherein said second layer of material has a thickness ranging from 0.010″ to 3″ and a resistivity ρ ranging from 1.5 to 20×10⁻⁸ ohm-meters.

16. A tablet according to claim 14, wherein said magnetic field is a dipole having a central plane extending substantially normal to said first major surface of said first layer of material.

17. A tablet according to claim 14, wherein said magnetic field is a dipole having a central plane extending substantially normal to said first major surface of said first layer of material.

18. A tablet according to claim 14, wherein each of said plurality of magnetic field generators has a coil or a coil equivalent having a major plane extending substantially normal to said first major surface of said first layer of material.

19. A tablet according to claim 14, wherein each of said plurality of magnetic field generators has a coil or a coil equivalent having a major plane extending substantially parallel to said first major surface of said first layer of material.

20. A magnetic field generator tablet, comprising:
a) a first layer of material that is electrically conductive and non-magnetic, said first layer of material having a first major surface and a second major surface opposite said first major surface;
b) a plurality of magnetic field generators located proximate said first layer of material, each of said generators having a coil or coil equivalent capable of generating a magnetic field, said coil or coil equivalent having a major plane extending substantially normal to said first major surface; and
c) wherein said first layer of material has a thickness and a resistivity ρ selected so that said first layer substantially eliminates via eddy currents any portions of said magnetic field that extends through said first layer of material past said second surface.

21. A tablet according to claim 20, wherein said magnetic field is a dipole having a central plane extending substantially parallel to said first major surface of said first layer of material.

22. A tablet according to claim 20, further including a bottom surface and a spacer layer for increasing the distance between said plurality of magnetic field generators and a distorter proximate said bottom surface.

23. A tablet according to claim 20, wherein said plurality of magnetic field generators includes a coil.

24. A tablet according to claim 20, wherein said plurality of magnetic field generators includes a magnet.

25. A magnetic field generator tablet for use in an environment having a magnetic field distorter, the tablet comprising:
a) a plurality of magnetic field generators that generate a plurality of magnetic fields, each of said generators having a coil or coil equivalent with a major plane extending in a first physical relationship to a first plane; and
b) means for distorting said magnetic fields so as to have a consistent configuration relative to said first plane irrespective of the presence of a magnetic field distorter located proximate said means.

26. A tablet according to claim 25, wherein said major plane extends substantially normal to said first plane.

27. A tablet according to claim 25, wherein said major plane extends substantially parallel to said first plane.

28. A tablet according to claim 25, wherein said means includes at least one of a layer of magnetic material and a layer of electrically conductive material.

29. A tablet according to claim 25, wherein said means includes a layer of magnetic material and a layer of non-magnetic electrically conducting material.

30. A position and orientation determination system, comprising:
a) a tablet including:
i) a first layer of material that is electrically conductive and non-magnetic, said first layer having a first major surface and a second major surface opposite said first major surface;
ii) a plurality of magnetic field generators located proximate said first layer, each of said generators having a coil or coil equivalent capable of generating a plurality of magnetic fields, said coil or coil equivalent having a major plane extending substantially normal to said first major surface; and
iii) wherein said first layer of material has a thickness and a resistivity ρ selected so that said first layer substantially eliminates via eddy currents any portions of said magnetic fields that extend through said first layer of material past said second surface;
b) a sensor for sensing said magnetic fields and providing an output signal having information representative of said magnetic fields; and
c) a processor connected to said tablet and said sensor for providing drive signals to said plurality of magnetic field generators and for determining the position and orientation of said sensor in space based on said information in said output signal.

31. A system according to claim 30, wherein said magnetic field is a dipole having a central plane extending substantially parallel to said first major surface.

32. A system according to claim 30, further wherein said drive signals are generated so as to cause each of said magnetic fields to have an attribute that differs from attributes of other ones of said magnetic fields.

33. A system according to claim 32, wherein said attribute is time.

34. A system according to claim 32, wherein said attribute is phase.

35. A system according to claim 32, wherein said attribute is frequency.

36. A position and orientation determination system comprising:
a) a tablet including: a first layer of material that is magnetically conductive, said first layer having a first major surface and a second major surface opposite said first major surface; a plurality of magnetic field generators located proximate said first layer of material, each of said generators having a coil or coil equivalent capable of generating a magnetic field, each coil or coil equivalent having a major plane extending substantially parallel to said first major surface; wherein said first layer of material has a thickness and a relative permeability μᵣ selected so that said first layer substantially prevents said magnetic fields from extending through said first layer and past said second major surface; a sensor for sensing said magnetic fields and providing an output signal having information representative of said magnetic fields; and
b) a processor connected to said tablet and said sensor for providing drive signals to said plurality of magnetic field generators and for determining the position and orientation of said sensor in space based on said information in said output signal.

37. A system according to claim 36, wherein said magnetic field is a dipole having a central plane extending substantially normal to said first major surface.

38. A system according to claim 36, further wherein said drive signals are generated so as to cause each of said magnetic fields to have an attribute that differs from attributes of other ones of said magnetic fields.

39. A system according to claim 38, wherein said attribute is time.

40. A system according to claim 38, wherein said attribute is phase.

41. A system according to claim 38, wherein said attribute is frequency.

42. A method of distorting magnetic fields, comprising:
a) providing a layer of magnetic material having a first thickness, a first relative permeability μᵣ, a first major surface and a second major surface opposite said second major surface;
b) providing a layer of non-magnetic, electrically conductive material having a first thickness, a first resistivity ρ, a first major surface and a second major surface opposite said first major surface;
c) positioning said layer of magnetic material and said layer of electrically conductive material proximate at least one magnetic field generator capable of generating a magnetic field;
d) generating at least one magnetic field with said at least one magnetic field generator; and
e) wherein said providing step a) involves selecting said first thickness and said first relative permeability μᵣ and said providing step b) involves selecting said first thickness and said first resistivity ρ so that in combination said layer of magnetic material and said layer of electrically conductive material substantially prevent said at least one magnetic field from extending through both said layer of magnetic material and said layer of electrically conductive material.
